(19) United States
(12) Patent Application Publication
(10) Pub. No.: US 2026/0200664 A1
(43) Pub. Date: Jul. 16, 2026

(54) MULTI-TIER DISPOSABLE EGG PAN

(71) Applicant: Faith Leslie Northington, Upper Chichester, PA (US)

(72) Inventor: Faith Leslie Northington, Upper Chichester, PA (US)

(21) Appl. No.: 19/562,502

(22) Filed: Mar. 10, 2026

Related U.S. Application Data
(60) Provisional application No. 63/833,727, filed on Jan. 10, 2025.

(51) Int. Cl. B65D 85/32; A47J 47/14; B65D 1/24; B65D 25/10; B65D 43/02

(52) U.S. Cl. CPC B65D 85/322; A47J 47/14; B65D 1/24; B65D 25/108; B65D 43/0233; B65D 2543/00194

(57) ABSTRACT

A multi-tier egg pan assembly includes a pan body having egg-receiving recesses in a bottom wall and openings in a peripheral sidewall. An insert shelf defining a second tier includes egg-receiving recesses and foldable flaps that extend through the sidewall openings and fold downward and/or tuck to support the insert shelf above the bottom wall. In some embodiments, an adhesive region on a flap secures to the pan body, and stabilizer pieces inserted through shelf slots engage the bottom wall to resist rocking. The assembly may be formed from food-safe sheet material such as aluminum and may be disposed of after use. A lid may cover the pan body for transport.

### CROSS-REFERENCE TO RELATED APPLICATIONS

This application claims the benefit of U.S. Provisional Patent Application No. 63/833,727, filed January 10, 2025, the entire disclosure of which is incorporated herein by reference.

### BACKGROUND OF THE INVENTION

The present disclosure relates generally to food containers and serving trays and, more particularly, to devices for holding and transporting cooked eggs, including deviled eggs.

Prepared eggs (e.g., hard-boiled eggs and deviled eggs) are commonly made in advance and transported to events such as parties, potlucks, and catered functions. Eggs and deviled eggs are prone to shifting and damage during transport, especially where the eggs are arranged in multiple layers or where toppings, garnishes, or fillings extend above an egg surface.

A variety of egg carriers and egg-holding devices exist. Some carriers are reusable molded plastic containers that hold a single layer of eggs and include a fitted lid. Other egg-holding devices rely on stacked or nestable trays, rigid racks, central posts, or dedicated covers and hardware intended for boiling, chilling, storage, or display. These approaches may require washing after use, may occupy substantial storage space when not in use, and may not provide a simple disposable solution that carries multiple layers of eggs within one pan footprint while resisting tier-to-tier contact and shifting.

Accordingly, a need exists for an egg-holding system that can be assembled quickly, that stably supports multiple tiers of eggs in a single pan, and that may be disposed of after use to reduce cleaning burdens, for example in catering and large-batch preparation workflows.

### BRIEF SUMMARY OF THE INVENTION

In some embodiments, a multi-tier egg pan assembly includes a pan body having a bottom wall and a peripheral sidewall that together define an interior cavity. The bottom wall includes a first plurality of egg-receiving recesses. The sidewall includes one or more openings that are configured to receive support features of an insert shelf.

In some embodiments, the assembly further includes an insert shelf positioned above the bottom wall within the interior cavity to define a second tier. The insert shelf includes a second plurality of egg-receiving recesses. The insert shelf further includes one or more foldable flaps (also referred to herein as tabs) configured to extend through respective openings of the sidewall and to be folded downward and/or tucked to support and stabilize the insert shelf above the bottom wall.

In some embodiments, an adhesive region is provided on at least a portion of a flap to secure the flap to a portion of the pan body (for example, to the bottom wall) after folding, thereby improving stability of the second tier. In some embodiments, the adhesive region is covered by a removable release liner prior to use.

In some embodiments, the insert shelf includes one or more slots configured to receive one or more stabilizer pieces. The stabilizer pieces may engage the bottom wall (and/or other structure) to resist rocking or collapse of the insert shelf during transport.

In some embodiments, the pan body and/or insert shelf are formed from a food-safe sheet material, such as aluminum or an aluminum alloy, such that the assembly may be disposed of after use. In some embodiments, the assembly includes a lid (e.g., a foil cover, a polymer lid, or other cover) configured to cover the pan body.

The features and advantages described above are not all-inclusive, and many additional features and advantages will be apparent to those skilled in the art in view of the following drawings and detailed description.

### BRIEF DESCRIPTION OF THE SEVERAL VIEWS OF THE DRAWING

FIG. 1 is a perspective view of an example multi-tier disposable egg pan assembly, showing a base pan, an insert shelf defining an upper tier, and an optional lid shown in phantom.

FIG. 2 is an exploded perspective view of the assembly of FIG. 1, showing the insert shelf above the base pan and optional stabilizer pieces.

FIG. 3 is a top plan view of the base pan of FIG. 1, showing egg-receiving recesses formed in a bottom wall and openings formed in a peripheral sidewall.

FIG. 4 is a top plan view of the insert shelf of FIG. 2, showing egg-receiving recesses, foldable flaps, fold regions, and stabilizer slots.

FIG. 5 is a side cross-sectional view of an assembled multi-tier disposable egg pan assembly, illustrating the insert shelf installed within the base pan and supported by flaps engaged through sidewall openings.

FIG. 6 is an enlarged detail view illustrating an example flap engaged through a sidewall opening and folded to support the insert shelf, and further illustrating an optional adhesive region.

### DETAILED DESCRIPTION OF THE INVENTION

In the following description, certain specific details are set forth in order to provide a thorough understanding of various disclosed embodiments. However, one skilled in the art will understand that the disclosed embodiments may be practiced without these specific details. In other instances, well-known structures and methods have not been shown or described in detail to avoid unnecessarily obscuring the descriptions of the embodiments.

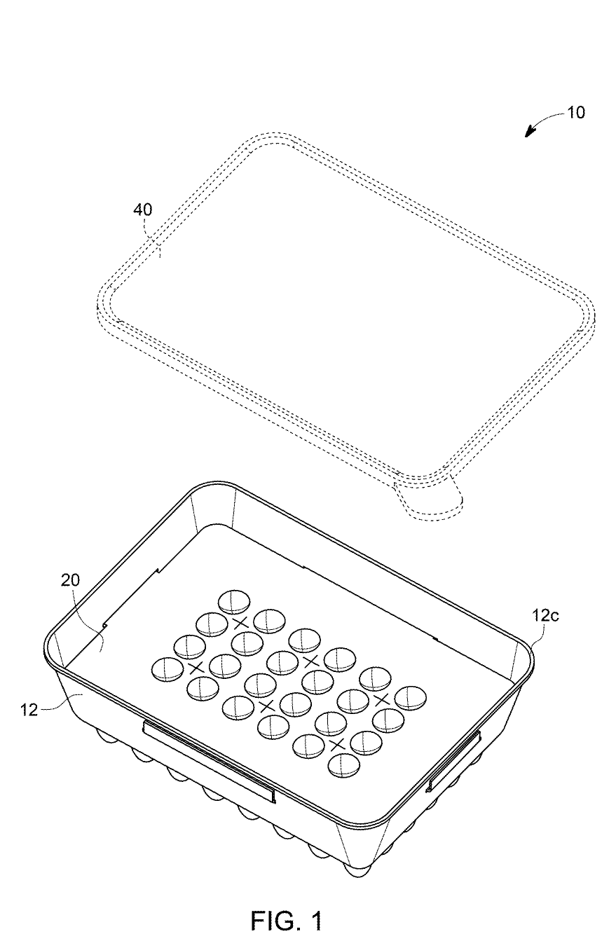

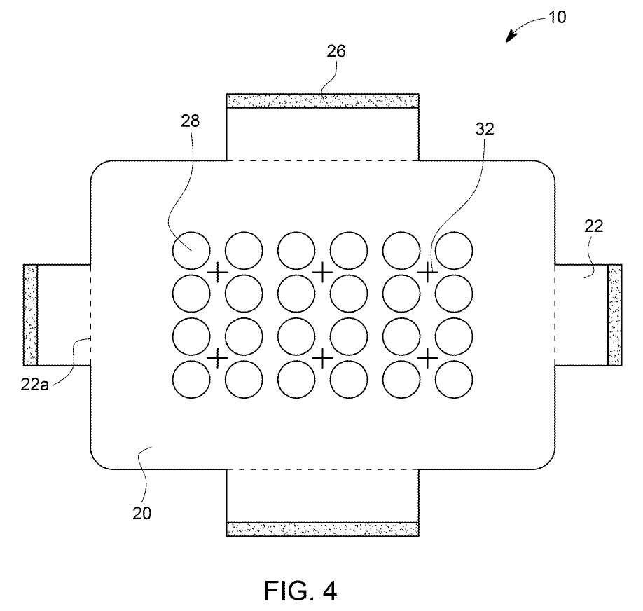

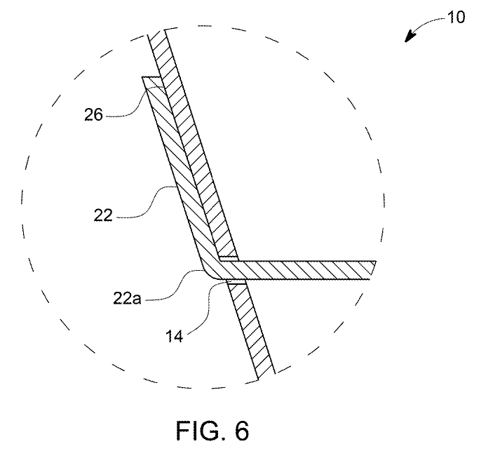

FIGS. 1-6 illustrate an example multi-tier egg pan assembly 10 (also referred to herein as an egg carrier). In some embodiments, the assembly 10 includes a base pan 12 and an insert shelf 20 configured to be supported within the base pan 12 to define at least two tiers for holding eggs. The assembly 10 may be configured to hold whole hard-boiled eggs, peeled eggs, deviled egg halves, or other egg preparations.

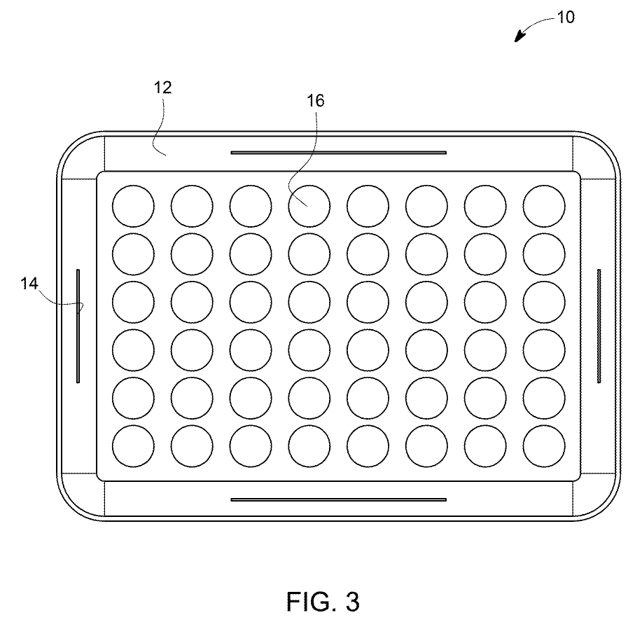

With reference to FIGS. 1 and 3, the base pan 12 includes a bottom wall 12a and a peripheral sidewall 12b extending upward from the bottom wall 12a. The bottom wall 12a and sidewall 12b define an interior cavity. In some embodiments, the sidewall 12b terminates at an upper rim 12c that may include a rolled edge or bead for stiffness and/or for engaging a lid.

The bottom wall 12a includes a first plurality of egg-receiving recesses 16. In some embodiments, each recess 16 is generally egg-shaped, oval, or circular in plan view and is contoured to cradle an egg, an egg half, or another egg portion. The recesses 16 may be formed by stamping, pressing, vacuum forming, or other forming processes suitable for the selected material.

In some embodiments, the sidewall 12b includes one or more openings 14 configured to receive support features of the insert shelf 20. The openings 14 may be formed as cutouts, slots, holes, windows, notches, or other apertures. In some embodiments, the openings 14 are positioned on opposed side portions of the sidewall 12b to receive opposed flaps of the insert shelf 20.

With reference to FIGS. 1, 2 and 4, the insert shelf 20 includes a plate sized to fit within the interior cavity of the base pan 12. The insert shelf 20 includes a second plurality of egg-receiving recesses 28. In some embodiments, the recesses 28 are generally aligned with, or offset relative to, the recesses 16 of the bottom wall 12a so that eggs on different tiers are spaced from one another.

The insert shelf 20 includes one or more foldable flaps 22 configured to support the insert shelf 20 above the bottom wall 12a. In some embodiments, the flaps 22 extend laterally from the plate and are dimensioned to pass through corresponding openings 14 in the sidewall 12b. Each flap 22 may include a fold region 22a (e.g., a scored line, crease, weakened line, perforation, or relief notch) that facilitates folding the flap 22 after insertion through the opening 14.

In some embodiments, after a flap 22 passes through a corresponding opening 14, the flap 22 is folded downward to engage an exterior surface of the sidewall 12b, an interior surface of the sidewall 12b, and/or a portion of the bottom wall 12a. In some embodiments, an end portion of the flap 22 is tucked under a portion of the base pan 12 (for example under a rim region and/or under itself) to resist upward movement of the insert shelf 20.

In some embodiments, an adhesive region 26 is provided on at least a portion of a flap 22. The adhesive region 26 may include, for example, a food-safe pressure-sensitive adhesive. In some embodiments, the adhesive region 26 is positioned near a distal end of the flap 22 and is configured to adhere to the bottom wall 12a and/or another portion of the base pan 12 when the flap 22 is folded downward, thereby improving stability of the insert shelf 20 during transport.

In some embodiments, the adhesive region 26 is covered by a removable release liner prior to use. A user may remove the release liner during assembly to expose the adhesive region 26.

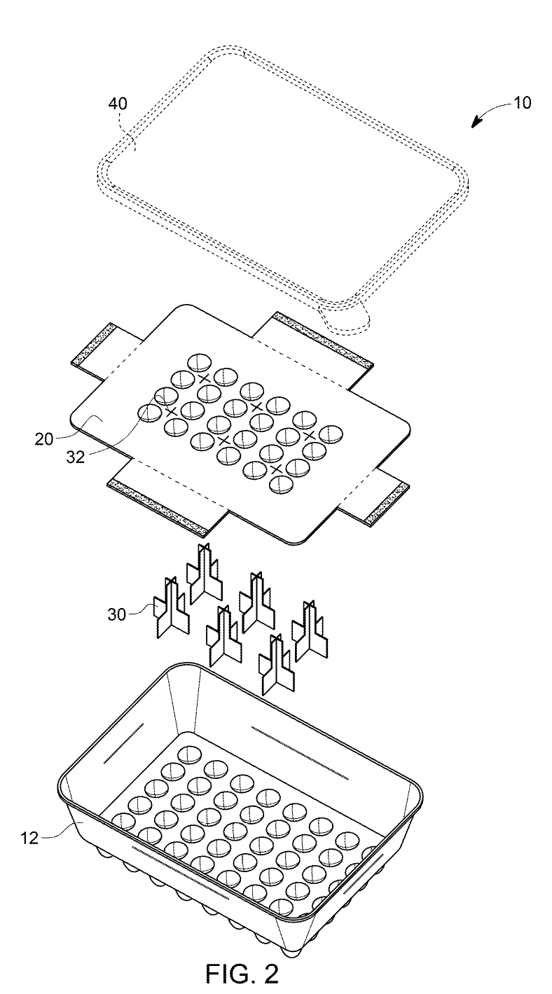

In some embodiments, the insert shelf 20 includes one or more stabilizer slots 32 (FIG. 2) configured to receive one or more stabilizer pieces 30. The stabilizer pieces 30 may extend downward from the insert shelf 20 to engage the bottom wall 12a and thereby provide supplemental support. The stabilizer pieces 30 may also resist rocking of the insert shelf 20 relative to the base pan 12.

In some embodiments, the stabilizer pieces 30 are provided as separate parts that are inserted through corresponding slots 32. The stabilizer pieces 30 may be formed from paperboard, polymer, aluminum, or other materials, and may have any suitable shape (including, for example, rectangular, cross-shaped, or X-shaped structures). In other embodiments, stabilizer structures are integrally formed with the insert shelf 20 (e.g., as formed ribs or folded sections).

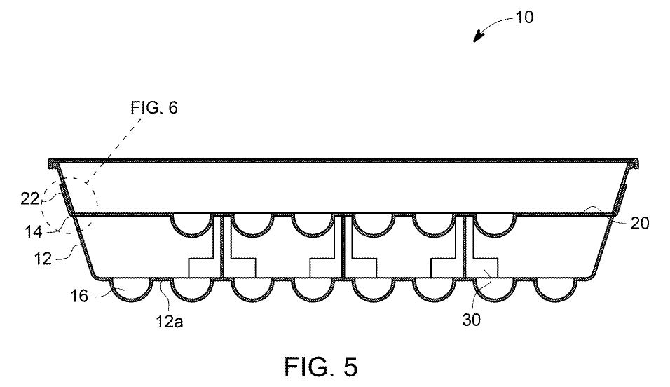

In some embodiments, the insert shelf 20 is positioned to provide a vertical clearance (FIG. 5) between eggs carried on the bottom wall 12a and eggs carried on the insert shelf 20. The clearance may be selected to reduce or prevent contact between eggs of different tiers during transport, including where deviled eggs include toppings or fillings.

In some embodiments, the assembly 10 includes a lid 40 (FIG. 1) configured to cover the base pan 12. The lid 40 may be a flexible cover (e.g., aluminum foil) crimped around the rim 12c, or may be a rigid or semi-rigid cover (e.g., a polymer lid) configured to snap-fit or otherwise engage the rim 12c.

In some embodiments, the base pan 12 and the insert shelf 20 are formed from one or more food-safe sheet materials. Example materials include aluminum or aluminum alloy foil, coated paperboard, and polymer sheet materials. In some embodiments, the base pan 12 is formed from aluminum foil, and the insert shelf 20 is formed from aluminum foil or coated paperboard. In some embodiments, the assembly 10 is configured for single-use such that the assembly 10 (or selected components thereof) may be disposed of after use, thereby reducing washing and cleanup.

In some embodiments, the base pan 12 is formed by stamping and drawing a sheet of aluminum foil to form the bottom wall 12a, sidewall 12b, and egg-receiving recesses 16. The openings 14 may be cut or punched in the sidewall 12b. The insert shelf 20 may be formed by stamping or pressing a sheet to form the recesses 28, and cutting or punching to define the flaps 22 and slots 32.

In some embodiments, to assemble the multi-tier egg pan assembly 10, the insert shelf 20 is positioned within the interior cavity above the bottom wall 12a. The flaps 22 are aligned with the openings 14 and pushed through the openings 14. The flaps 22 are then folded downward and, in some embodiments, tucked and/or adhered to the base pan 12. Stabilizer pieces 30 may be inserted through stabilizer slots 32 as desired. Eggs may then be placed in the recesses 16 and 28, and the base pan 12 may be covered by the lid 40.

In some embodiments, the assembly 10 includes more than two tiers. For example, a second insert shelf may be supported above the insert shelf 20 by additional openings and flaps, by additional stabilizer pieces, and/or by other support structures to define a third tier. The number, spacing, and arrangement of tiers may be selected based on a desired egg capacity and a desired overall height.

Although the illustrated embodiments show a generally rectangular base pan 12, the base pan 12 may have other shapes, including oval, circular, or polygonal shapes. The recesses 16 and 28 may be arranged in rows and columns or in other patterns, and the recess shapes may be adjusted for whole eggs, egg halves, quail eggs, or other foods. In some embodiments, the recesses are fully formed depressions. In other embodiments, the recesses are formed by partially raised ribs, dimples, or other contours that limit egg movement.

The above description is illustrative and not restrictive. Various changes or modifications in form and detail may be made without departing from the spirit and scope of the present disclosure. The scope of the disclosure is determined by the claims that follow.

What is claimed is:

1. A multi-tier egg pan assembly, comprising:
a pan body comprising a bottom wall and a peripheral sidewall defining an interior cavity, the bottom wall having a plurality of egg-receiving recesses, the sidewall having a plurality of openings;
an insert shelf positioned within the interior cavity above the bottom wall, the insert shelf having a plurality of egg-receiving recesses and a plurality of foldable flaps; and
wherein each foldable flap is configured to extend through a corresponding opening of the sidewall and to be folded to a supporting configuration to support the insert shelf above the bottom wall.

2. The assembly of claim 1, wherein the pan body is configured for single use and disposal.

3. The assembly of claim 2, wherein the pan body comprises a food-safe sheet material.

4. The assembly of claim 3, wherein the food-safe sheet material comprises aluminum or an aluminum alloy.

5. The assembly of claim 1, wherein at least a portion of the openings comprises slots formed in opposed side portions of the peripheral sidewall.

6. The assembly of claim 1, wherein at least one of the foldable flaps includes an adhesive region configured to adhere to a portion of the pan body when the at least one foldable flap is in the supporting configuration.

7. The assembly of claim 6, wherein the adhesive region is covered by a removable release liner prior to use.

8. The assembly of claim 1, wherein the insert shelf includes one or more stabilizer slots, and further comprising one or more stabilizer pieces insertable through the one or more stabilizer slots to engage the bottom wall.

9. The assembly of claim 8, wherein at least one stabilizer piece comprises an intersecting cross-shaped structure configured to contact the bottom wall at a plurality of locations.

10. The assembly of claim 8, wherein at least one stabilizer piece comprises a paperboard or polymer material.

11. The assembly of claim 1, wherein at least one foldable flap includes a distal end portion configured to be tucked under a portion of the pan body to resist upward movement of the insert shelf.

12. The assembly of claim 1, wherein the insert shelf is positioned to define a vertical clearance between eggs carried on the bottom wall and eggs carried on the insert shelf that reduces contact between tiers during transport.

13. The assembly of claim 1, further comprising a lid configured to cover the pan body.

14. The assembly of claim 13, wherein the lid comprises a flexible foil cover configured to be crimped around an upper rim of the pan body.

15. The assembly of claim 13, wherein the lid comprises a rigid or semi-rigid polymer cover configured to engage an upper rim of the pan body.

16. The assembly of claim 1, further comprising a second insert shelf positioned above the insert shelf to define a third tier.

17. A method of transporting eggs, comprising:
placing eggs in egg-receiving recesses of a bottom wall of a pan body;
positioning an insert shelf within the pan body above the bottom wall;
inserting foldable flaps of the insert shelf through openings in a sidewall of the pan body;
folding the foldable flaps to support the insert shelf above the bottom wall;
placing additional eggs in egg-receiving recesses of the insert shelf; and
covering the pan body with a lid for transport.

18. The method of claim 17, further comprising adhering at least one folded flap to a portion of the pan body using an adhesive region on the flap.

19. The method of claim 17, further comprising inserting one or more stabilizer pieces through stabilizer slots in the insert shelf such that the stabilizer pieces engage the bottom wall.

20. The method of claim 17, wherein the eggs comprise deviled egg halves.
